(19) United States
(12) Patent Application Publication
(10) Pub. No.: US 2007/0107217 A1
(43) Pub. Date: May 17, 2007

(54) Method for surface blasting of integrally bladed rotors

(75) Inventors: Andreas Baus, Muenchen (DE); Goetz Lebkuechner, Germering (DE); Rolf-Juergen Picard, Wuppertal (DE)

Correspondence Address: CROWELL & MORING LLP;INTELLECTUAL PROPERTY GROUP, P.O. BOX 14300, WASHINGTON, DC, 20044-4300, US

(73) Assignee: MTU Aero Engines GmbH, Munich (DE)

(21) Appl. No.: 11/443,407

(22) Filed: May 30, 2006

(30) Foreign Application Priority Data
May 31, 2005 (DE) 10 2005 024 733.4

(51) Int. Cl. B23P 6/00

(52) U.S. Cl. 29/889.1

(57) ABSTRACT

A method for surface blasting of integrally bladed rotors is disclosed. In an embodiment, the method includes: a) providing an integrally bladed rotor; b) providing a vibratory grinding. system; c) arranging the integrally bladed rotor in a grinding container of the vibratory grinding system; d) filling the grinding container of the vibratory grinding system with blasting balls; and e) operating the vibratory grinding system filled with the blasting balls and the integrally bladed rotor to accelerate the blasting balls, wherein the accelerated blasting balls simultaneously strengthen the integrally bladed rotor on the surfaces of all the rotor blades and in the annular space between neighboring rotor blades.

This application claims the priority of German Patent Document No. 10 2005 024 733.4, filed May 31, 2005, the disclosure of which is expressly incorporated by reference herein.

### BACKGROUND AND SUMMARY OF THE INVENTION

The invention relates to a method for surface blasting integrally bladed rotors, in particular integrally bladed gas turbine rotors.

Gas turbines, especially aircraft engines, have at least one rotor equipped with rotating blades, especially in the area of the compressor and/or turbine; there is a growing trend for these blades to be designed as an integral part of the rotor. Integrally bladed rotors are referred to as either blisk (bladed disk) or bling (bladed ring), depending on whether the rotor base body is disk-shaped or ring-shaped. During operation of a gas turbine, the rotors are under very high loads. To reduce the wear rate, integrally bladed rotors are strengthened by special surface processing techniques.

Shot peening or blasting with steel balls, i.e., shot, is used for surface bonding of integrally bladed rotors in the related art. In this method according to the related art, blasting balls, which may be in the form of steel balls or even ceramic balls, are accelerated with the help of compressed air or directed through at least one nozzle at the surface sections of the integrally bladed rotor that are to be strengthened. With such nozzles, only a narrowly limited section, i.e., surface area of the integrally bladed rotor, can be strengthened, so the nozzle or each nozzle directing the peening balls used for surface strengthening at the integrally bladed rotor must move or be moved in relation to the integrally bladed rotor. According to the related art, surface areas of the blades of the integrally bladed rotor and surface areas of the hub and/or annular clearance between neighboring blades are blasted one after the other with different nozzle settings. It follows directly from this that the method used for surface blasting of integrally bladed rotors according to the related art takes a very long time and is also associated with high equipment costs.

Against this background, the problem on which the present invention is based is to create a novel method for surface blasting of integrally bladed rotors.

According to this invention, in an embodiment, the method for surface blasting of integrally bladed rotors includes at least the following steps: a) providing an integrally bladed rotor; b) providing a vibratory grinding system; c) arranging the integrally bladed rotor in a grinding container of the vibratory grinding system; d) then filling the grinding container of the vibratory grinding system with blasting balls; e) operating the vibratory grinding system filled with the blasting balls and the integrally bladed rotor to accelerate the blasting balls, so that the accelerated blasting balls strengthen the integrally bladed rotor simultaneously on the surfaces of all rotor blades and in the annular clearance between neighboring rotor blades.

In the sense of the present invention, it is provided that a vibratory grinding system that is generally used for abrasive vibratory grinding and/or chemically supported vibratory grinding should be used for surface blasting of integrally bladed rotors. To do so, the integrally bladed rotor whose surface is to be strengthened is positioned in the grinding container of the vibratory grinding system, while the grinding container is still filled with steel balls. By operating the vibratory grinding system filled with the integrally bladed rotor and the steel balls, the integrally bladed rotor is simultaneously strengthened on the surfaces of all the rotor blades and on the surface of the hub and/or in the area of the annular clearance between the neighboring rotor blades. This makes it possible to significantly shorten the process time needed for surface blasting of integrally bladed rotors. The vibratory grinding system that is needed anyway for vibratory grinding is sent for another use in the sense of the present invention, namely surface strengthening and/or surface blasting, thereby making it possible to reduce equipment costs.

### BRIEF DESCRIPTION OF THE DRAWINGS

Preferred embodiments of the present invention are derived from the following description. An exemplary embodiment of this invention is explained in greater detail with reference to the drawings without being limited thereto. The figures show:

FIG. 1 is an arrangement consisting of a vibratory grinding system and an integrally bladed rotor to be strengthened in the area of its surface, shown in cross-section to illustrate the inventive method; and

FIG. 2 is the area of detail II of the arrangement according to FIG. 1 as seen from above.

### DETAILED DESCRIPTION OF THE DRAWINGS

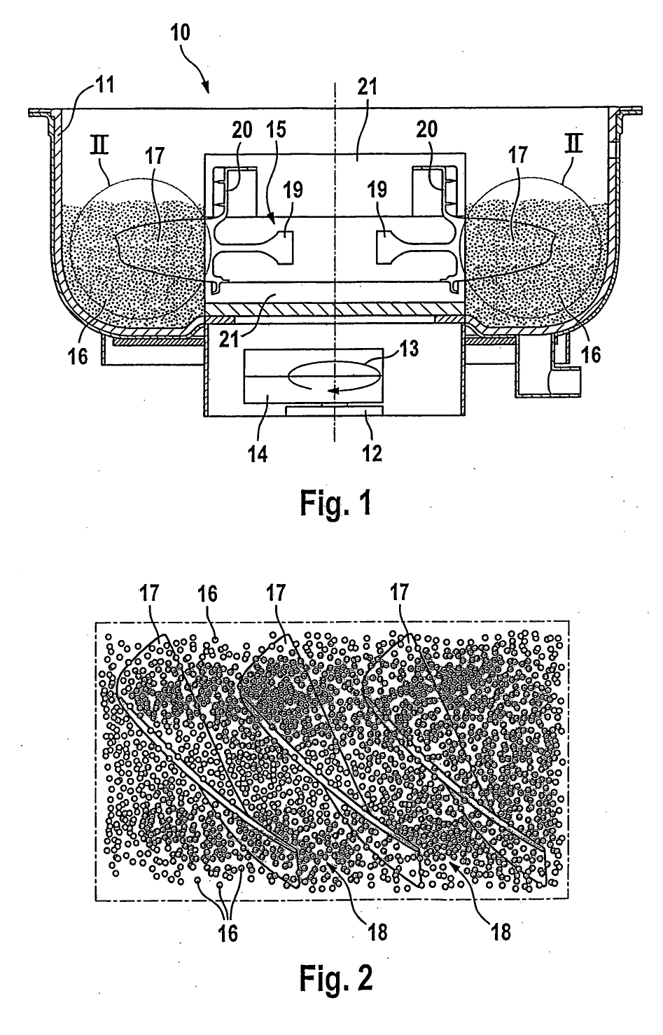

The present invention is described in greater detail below with reference to FIGS. 1 and 2.

FIG. 1 shows a schematic diagram of a vibratory grinding system 10 comprising a grinding container 11 and a motor 12 permanently connected to the grinding container 11. The motor 12 is driven in operation of the vibratory grinding system 10 and in doing so, it rotates an unbalanced body 14 in the direction of the arrow 13. The rotation of the unbalanced body 14 induces a tumbling motion of the grinding container 11.

In the sense of the present invention, for surface blasting of an integrally bladed rotor 15, it is positioned in the grinding container 11 of the vibratory grinding system 10. In addition, the grinding container 11 of the vibratory grinding system 10 is filled with blasting balls 16; the balls may be designed as ceramic balls or steel balls. As FIGS. 1 and 2 indicate, the blasting balls 16 are placed in the grinding container 11 in such a way that the integrally bladed rotor 15 is surrounded by the blasting balls 16 on all sides in the area of its rotor blades 17 and in the area of its hub and/or the annular clearance 18 between neighboring rotor blades 17.

In operation of the vibratory grinding system 10 filled with the blasting balls 16 and the integrally bladed rotor 15, the grinding container 11 and the integrally bladed rotor 15 execute a tumbling motion, so the blasting balls 16 are accelerated in relation to the grinding container 11, as well as the integrally bladed rotor 15, and they travel on helical paths through the grinding container 11. In this process, the blasting balls 16 strike the surfaces of the integrally bladed rotor 15 and, in doing so, deliver their energy to same. The integrally bladed rotor 15 is surface-blasted and/or surface-strengthened at the same time in this way in the area of all the rotor blades 17 and in the area of the hub and/or the annular clearance 18 between neighboring rotor blades 17.

The integrally bladed rotor 15 is preferably arranged in the grinding container 11 of the vibratory grinding system 10 in such a way that the integrally bladed rotor 15 is rigidly connected to the grinding container 11, i.e., there is no degree of freedom for any relative movement between the integrally bladed rotor 15 and the grinding container 11. Then the grinding container 11 and the integrally bladed rotor 15 execute an identical tumbling motion in operation of the vibratory grinding system 10 for surface blasting of the rotor 15.

As an alternative, it is also possible to arrange the integrally bladed rotor 15 in the grinding container 11 of the vibratory grinding system 10 in such a way that the integrally bladed rotor 15 is connected to the grinding container 11 of the vibratory grinding system 10 while retaining one degree of freedom for a relative movement between the rotor 15 and the grinding container 11. With regard to the grinding container 11, the integrally bladed rotor 15 can then move about an axis of rotation in relation to the grinding container 11 but, in the axial direction, it is rigidly connected to the grinding container 11.

Thus, with the inventive method, an integrally bladed gas turbine rotor 15 is strengthened, e.g., by hardening, solidifying, or consolidating, simultaneously in the area of all the rotor blades 17 and the hub and/or the annular space 18 between neighboring rotor blades 17, i.e., on all aerodynamically and/or hydrodynamically relevant surface areas of the integrally bladed rotor. According to FIG. 1, surfaces of the integrally bladed rotor 15 that are not to be strengthened, e.g., surface areas on the inside radially of rotor disks 19 and surface areas on gasket carriers 20, are covered with the help of cover devices 21 to prevent the blasting balls 16 from striking these surface areas. As an alternative, however, it is also possible to simultaneously blast one or more of the surface areas covered by the cover devices 21 in FIG. 1 at the same time with the other surface areas.

### List of Reference Numerals

10 vibratory grinding system
11 grinding container
12 motor
13 direction of movement
14 unbalanced body
15 integrally bladed rotor
16 blasting balls
17 rotor blade
18 annular space
19 rotor disk
20 gasket carrier
21 cover device

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof

What is claimed is:

1. A method for surface blasting of integrally bladed rotors, in particular integrally bladed gas turbine rotors, comprising the steps of:
a) providing an integrally bladed rotor having rotor blades;
b) providing a vibratory grinding system;
c) arranging the integrally bladed rotor in a grinding container of the vibratory grinding system;
d) filling the grinding container of the vibratory grinding system with blasting balls; and
e) operating the vibratory grinding system filled with the blasting balls and the integrally bladed rotor to accelerate the blasting balls, wherein the accelerated blasting balls simultaneously strengthen the integrally bladed rotor on all exposed surfaces of all of the rotor blades and in an annular space between neighboring rotor blades.

2. The method according to claim 1, wherein the integrally bladed rotor is arranged in the grinding container of the vibratory grinding system in such a way that the integrally bladed rotor is rigidly connected to the grinding container of the vibratory grinding system.

3. The method according to claim 1, wherein the integrally bladed rotor is arranged in the grinding container of the vibratory grinding system in such a way that the integrally bladed rotor is connected to the grinding container of the vibratory grinding system with one degree of freedom for a relative movement between the rotor and the grinding container.

4. The method according to claim 3, wherein the integrally bladed rotor is connected to the grinding container in such a way that the rotor is rotatable about its axis of rotation with respect to the grinding container.

5. A method for surface blasting an integrally bladed rotor comprising surface blasting the integrally bladed rotor by a vibratory grinding system.

6. A method for surface blasting an integrally bladed rotor, comprising the steps of:
disposing the integrally bladed rotor in a grinding container of a vibratory grinding system;
moving the grinding container and the integrated bladed rotor;
accelerating blasting balls contained within the grinding container by the step of moving the grinding container; and
simultaneously impacting all exposed surfaces of the integrally bladed rotor by the accelerated blasting balls.

7. The method according to claim 6, wherein the exposed surfaces of the integrally bladed rotor include an annular space between adjacent blades of the rotor.
